(19) United States
(12) Patent Application Publication
(10) Pub. No.: US 2011/0179911 A1
(43) Pub. Date: Jul. 28, 2011

(54) Wrench for Removal of Motor Vehicle Radiator Cap and/or Oil Filter Cap

(75) Inventor: Michael L. Whitehead, Clarinda, IA (US)

(73) Assignee: Lisle Corporation, Clarinda, IA (US)

(21) Appl. No.: 12/695,473

(22) Filed: Jan. 28, 2010

(51) Int. Cl. B25B 13/50; B25B 27/14

(52) U.S. Cl. 81/3.4; 81/124.6

(57) ABSTRACT

An automotive repair tool for removal of an engine fluid cap includes a scalloped interior opening through a circular base having a circumferential edge surface transverse to the axis of the rotation of the cap. The base receives a U-shape metal bracket welded thereto and aligned axially with the rotational axis of the base member. The opening through the base member is compatible with and generally congruent with a fluid cap for an internal combustion automobile engine.

### BACKGROUND OF THE INVENTION

In a principal aspect the present invention relates to an automotive repair tool useful for removing a fluid cap of a vehicle engine wherein the cap has a scalloped, generally circular circumferential edge surface transverse to the axis of the rotation of the cap.

When repairing an automobile vehicle engine or when replacing various fluids associated with the operation of an engine, a mechanic necessarily needs access to fluid tubes that enable pouring or injection of fluids into the engine or ancillary components associated with the engine. Such fluid tubes typically include a cylindrical cap which must be removed to enable access to the fluid tube. Further, such a cap may include an edge surface which is generally parallel to the axis of the cap and which has a shaped pattern, for example, a scalloped pattern. The scalloped pattern facilitates engagement by the hand of a mechanic to facilitate a manual grip on the cap so that it may be rotated and threaded or unthreaded onto or from the fluid tube. Despite such a design, many caps are still quite difficult to remove from the tube to which they are attached. As a consequence, various tools such as a pliers may be utilized to effect removal of a cap. Nonetheless there has developed a need for an improved tool or wrench device which facilitates cap removal and/or replacement. Such a tool must be rugged, provide for access to restricted areas of a vehicle engine inside an engine compartment, be efficient, be low cost and be easy to use.

### SUMMARY OF THE INVENTION

Briefly the present invention comprises an automotive repair tool designed for removal of engine fluid caps of the type having a scalloped, generally circular circumferential edge surface which is transverse to the axis of rotation of the cap. The tool is comprised of a flat, unitary, generally circular, planar sheet metal base having a center axis coincident with the axis of rotation of the cap to be removed. A patterned opening extends or is provided through the base. The patterned opening is designed to be fitted against and thus is generally congruent with the edge surface of the cap. The base thus comprises a generally annular outer rim having a generally circular outer rim surface with a patterned central opening.

The tool further includes a U-shaped, sheet metal, unitary bracket attached or welded to the base. The bracket includes first and second, spaced, flat planar legs connected by a flat transverse cross member. The legs and cross member have a uniform width. The legs are fastened respectively to opposite sides of the rim of the base and are aligned coincidently with a diameter of the base. They are symmetrical with respect to the center axis of the base and are connected together by the cross member which is also generally coincident with the base diameter. The cross member is parallel to and spaced from the base. The cross member includes a key drive opening which is axially aligned with the center axis of the patterned opening of the base and is configured to receive a mechanical drive.

Thus, the base is capable of being positioned with the patterned opening fitted against the edge surface of the engine cap. The cross member is spaced adequately from the cap to enable the base to be engaged manually or by a drive even if the cap is recessed and somewhat inaccessibly located in an engine compartment. The cross member may receive a drive such as a ratchet drive to effect rotation of the cap either to remove the cap or replace the cap on an appropriate fluid tube. The base and cross member are formed from an equal thickness, flat, sheet metal material in at least one of the embodiments. The legs of the bracket are generally rectangular as is the bracket cross member. The outer rim, which has a diameter D, has the legs attached thereto. The parallel legs are spaced from each other less than the diameter D.

Thus it is an object of the invention to provide an improved automotive tool which is designed to effect removal of an engine fluid cap in the engine compartment of a motor vehicle.

Yet a further object of the invention is to provide an automotive tool for removal of an engine fluid cap which is designed to enable removal of a cap which might otherwise be inaccessible and which is also designed to provide for engagement with a drive such as a ratchet drive to provide a mechanical advantage when removing or replacing such a cap.

Yet a further object of the invention is to provide an automotive tool which is rugged, easy to use, and generally inexpensive.

These and other objects, advantages, and features of the invention will be set forth in a detailed description as follows.

### BRIEF DESCRIPTION OF THE DRAWING

In the detailed description which follows, reference will be made to the drawing comprised of the following figures:

FIG. 1 is a top plan view of an embodiment of the tool of the invention;

FIG. 2 is a side view of the embodiment of FIG. 1;

FIG. 3 is a isometric view illustrating the manner of use of the tool of FIGS. 1 and 2; and

FIG. 4 is a further isometric view illustrating the manner of use of the tool of FIGS. 1 and 2 in combination with a drive such as a ratchet drive.

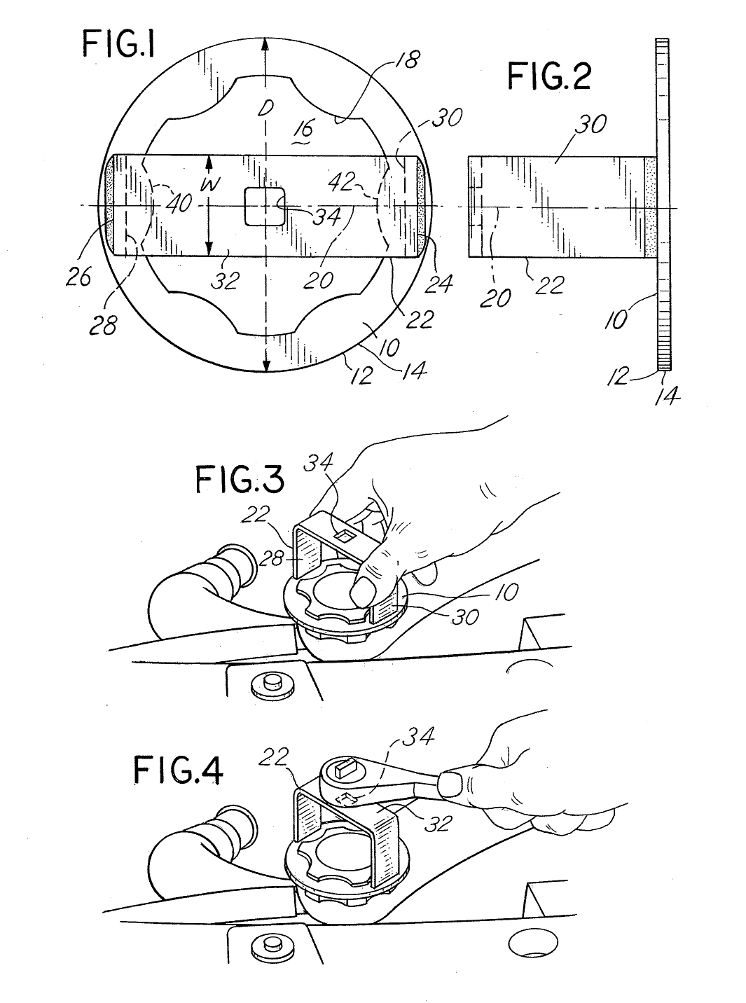

### DESCRIPTION OF AN EMBODIMENT OF THE INVENTION

Referring to the Figures the automotive repair tool is comprised of a generally thin, flat planar base 10 formed from a sheet of metal and thus is a unitary element defining a generally circular outer rim 12 having a generally circular outer surface 14. The base 10 includes an opening or through passage 16. Side surface 18 of the through passage 16 has a patterned, scalloped opening configuration. The sheet metal base 10 and opening 16 include a center line axis 20 which is transverse to the plane of the base 10. The patterned, scalloped opening 16 is designed to be compatible with the lateral side surface of a cap used to close a tube of a vehicle engine. The patterned opening 16 is thus congruent with the circumferential edge surface of a cap as illustrated in greater detail in FIGS. 3 and 4. The patterned opening 16 may be made in any particular desired scalloped pattern. Additionally, an insert (not shown) may be incorporated and attached to the inside surface 18 of the opening 16 to provide for alternative opening shapes of the tool. Opening 16 is generally symmetric about axis 20.

A U-shaped, sheet metal, unitary bracket 22 is welded at its opposite ends 24 and 26 to a surface of the base 10. The U-shaped metal bracket 22 is comprised of a first leg 28 which is generally rectangular and a second leg 30 which is substantially identical in size, shape and configuration to the first leg 28. The legs 28 and 30 are generally parallel to the axis 20. The legs 28 and 30 are connected by a cross member 32. A drive opening 34 is positioned at the center of the cross member 32 and is co-axial with the axis 20 so that the bracket 22 including the various elements of the bracket 22 are symmetrical about the axis 20. The cross member 32 has a width W which is less than about one half of the diameter D of the base 10. Thus, because the width W of the cross member 32 is limited in dimension, it may be easily manually gripped yet provide adequate strength for engagement by a drive through the drive opening 34. The opposite ends of the legs 28 and 30 are spaced a distance less than and are thus welded within the diameter, D, of the base 10. Consequently, the legs 28, 30 and the weldment associated therewith do not project beyond the side surface 14 of the base 10. The bracket 22 is positioned symmetrically with respect to scalloped surfaces 40 and 42 of the base 10. The scalloped surfaces are surfaces which project inwardly toward the axis 20. By positioning the bracket legs 28 and 30 appropriately as described, the weldment thereof is enhanced and the legs 28, 30 are thus welded to a more substantial portion of the base 10.

The cross member 32 is spaced from the surface of the base 10 by a distance substantially equal to at least about two thirds of the diameter D. This facilitates gripping manually. It also facilitates access to a cap which is positioned within the interior of an engine compartment and would otherwise be substantially inaccessible.

As depicted in FIGS. 3 and 4 the configuration of the interior opening surface 18 of the base 10 may be designed for cooperation with specific cap constructions. Thus a number of the tools may be provided in a kit having various sizes and shapes for use with various types of caps. Alternatively, opening 16 may be designed to be useful with multiple configurations of caps, for example, by the design of the shape and number of scalloped surfaces (eg. 40, 42). Alternate scallops may be omitted. Scallops may be configured to cooperate with distinctly different patterns of cap designs. Typically, however, the opening 16 will have a design congruent with a particular cap configuration so that the flutes of the cap are fitted over to be engaged by the opening 16 in base 10.

While there has been set forth an embodiment of the invention, it is to be understood that the invention is to be limited only by the following claims and equivalents thereof.

What is claimed is:

1. An automotive repair tool for removal of an engine fluid cap having a scalloped, generally circular circumferential edge surface transverse to the axis of rotation of the cap, said tool comprising:
a flat, unitary, generally circular planar sheet metal base with a center axis coincident with the axis of rotation of said cap, a patterned opening through the base to provide a generally annular outer rim having an outer rim surface, said patterned opening configured generally congruent with the circumferential edge surface of said cap; and
a U-shaped, sheet metal, unitary bracket including first and second spaced, flat planar legs connected by a flat, transverse cross member, said legs and cross member having a uniform width, said legs fastened respectively to opposite sides of the base and aligned coincident with a diameter of the base and symmetrically aligned with the center axis of the base, said cross member generally coincident with said base diameter and parallel to and spaced from the base, said cross member including a key drive opening axially aligned with the center axis of the base and configured to receive a mechanical drive whereby the base patterned opening is capable of being positioned with said patterned opening fitted against the edge surface of the cap and with said cross member spaced from said cap for receipt of a drive or manual actuation to effect rotation of said cap.

2. The tool of claim 1 wherein said base and cross member are formed from equal thickness sheet metal, said outer rim surface is circular, said legs are generally rectangular, said outer rim has a diameter D, and said legs are spaced from each other less than the diameter D.
